(19) United States
(12) Patent Application Publication
(10) Pub. No.: US 2025/0246343 A1
(43) Pub. Date: Jul. 31, 2025

(54) INSTALLATION DESIGNED AS A PIVOT MACHINE FOR ASSEMBLING CABLES

(71) Applicant: Komax Holding AG, Dierikon (CH)

(72) Inventors: Stefan Viviroli, Horw (CH); Alois Conte, Ebikon (CH)

(21) Appl. No.: 19/033,629

(22) Filed: Jan. 22, 2025

(30) Foreign Application Priority Data
Jan. 29, 2024 (EP) 24154305.7

(51) Int. Cl. H01B 13/00

(52) U.S. Cl. CPC H01B 13/0036

(57) ABSTRACT

An installation for assembling cables includes two pivot units and a processing station processing cable ends of the cable, a loop layer forming cable loops from the cable, a loop stretcher and a loop holder having a gripper securing the cable loop. The loop layer and the second pivot unit place the fully assembled cable loop on a cable tray using respective cable grippers. The cable tray is a conveyor having holding elements that hold both cable ends of the cable loop.

### FIELD

The invention relates to an installation for assembling cables, the installation having at least one first pivot unit and at least one processing station for processing cable ends of the cable and a loop layer for forming cable loops from the cable.

### BACKGROUND

When assembling cables, cable ends of the cables are processed. One such processing step is crimping, for example. “Crimping” is understood to mean the production of a non-detachable electrical and mechanical connection (crimp connection) by plastic deformation between a conductor and a crimp contact. For a higher requirement with regard to tightness, the stripped cable ends can be equipped with sleeves in sleeve stations before the crimping.

A generically comparable installation has become known from EP 1 447 888 A1 that shows a cable processing device with a stripping unit and two crimping stations with crimping presses. The apparatus also has a cable feed designed as a belt drive for moving the cable along a longitudinal axis of the machine. The stripping unit for cutting to length and stripping the cable ends is arranged on the longitudinal axis of the machine. Since the two crimping press stations are located alongside the longitudinal axis of the machine, however, the cable needs to be guided from pivot units to the respective crimping presses for the crimping stations by means of pivot arms provided with grippers, which is why this kind of cable processing devices is also known and familiar to the person skilled in the art and referred to as “pivot machines.” An installation designed as a pivot machine for assembling cables is shown in FIGS. 1 and 2 of the accompanying drawings.

In order to save space with long cables, the cable can be formed into a cable loop. However, it is also conceivable that assembled cables are to be available as cable loops for further processing. U.S. Pat. No. 5,740,608 A shows a pivot machine that forms loops with the cables during processing and moves the cable loops individually to the end of the machine by a transport belt equipped with cams or projections, in order to drop the cable loops into a removal container. Although this pivot machine achieves a shortening of the machine, it also has the disadvantage that only one batch is provided for removal.

### SUMMARY

It is therefore an object of the present invention to avoid the disadvantages of the known installation and, in particular, to create an installation for assembling cables that can be operated efficiently and safely.

According to the invention, these and other objects are achieved with an installation having the features described herein. The installation for assembling cables can have a cable conveying device running along a longitudinal axis of the machine for transporting the cable in a cable feed or cable transport direction to at least one processing station. The cable conveying device is preferably formed as a cable feed. The cable transporting apparatus, which is preferably formed as a cable feed, can be designed as a roller drive or belt drive. The installation also has at least one first pivot unit comprising a pivot arm, preferably rotatable about a vertical axis, with a cable gripper and at least one processing station assigned to this pivot unit and arranged laterally with respect to the longitudinal axis of the machine or next to the longitudinal axis of the machine for processing preferably stripped cable ends of the cable. This processing station comprises one or more processing modules, wherein a crimping module with a crimping press, a sleeve module and a housing equipping module, for example, can be considered as processing modules. The first pivot unit is used to feed the leading cable end coming from the cable conveying device to the processing station with the processing modules. The arrangement can also have a cutting and stripping station for cutting and stripping the cable. This cutting and stripping station is preferably arranged on the longitudinal axis of the machine. Cutting creates a second cable end, the trailing cable end. The trailing cable end can be processed with a second pivot unit and its assigned processing station. The second pivot unit is preferably constructed in the same way as the first pivot unit, but on the other side of the installation with respect to the longitudinal axis of the machine. The installation, which is designed as a pivot machine, then comprises a loop layer for forming cable loops from the cable and a cable tray for at least temporarily receiving a batch of fully assembled cable loops. The loop layer can have a cable gripper for gripping the first or leading cable end of the cable and for laying the cable loop. For example, the cable gripper of the loop layer can be rotatable about an axis, so that it forms an arc-shaped rotary movement to form the loop, which can then be brought to the desired length by further feeding the cable by means of the aforementioned cable transporting apparatus. At the end of this rotary movement, the leading cable end is rotated by 180°, for example. The cable tray could be designed as a receiving trough. However, it is advantageous if the cable tray has a flat resting surface for precise and orderly placement. This makes possible the advantageous handling for batches with a large number of cable loops and even for multiple batches. As a rule, a batch consists of a plurality of cables of the same type (same cross-section and color), which have the same length, are assembled in the same way and are present as cable loops; however, a batch can also consist of just one cable forming a cable loop. The different batches can be easily separated from one another, as a result of which their further use, for example in a subsequent machine or for transport, is significantly simplified. It can be particularly advantageous if the cable tray has a horizontal resting surface.

As a result of the fact that the installation comprises a loop stretcher and/or a loop holder formed by a gripper for securing the cable loop, the cable can be guided in an optimal manner when forming and extending the loop. In this context, “securing” primarily means preventing the unwanted rolling over of the cable during loop formation. The loop stretcher is a means for stretching the cable loop, which acts on the loop in the region of the apex; the loop stretcher can therefore subject the cable to a tensile load at the apex of the loop, so that the loop is stretched (and guided). The loop stretcher can be, for example, a pull-out gripper. However, the loop stretcher can also be a transfer element, i.e., in contrast to the pull-out gripper, a passive element that is or becomes wrapped by the cable. The loop holder acts on the cable loop in its lateral region, i.e., not on the apex, but on one of the regions that run approximately in the same direction and ideally even approximately parallel to one another, which connect to the apex or meet there. The loop holder can be a gripper that loosely grasps the cable of the cable loop from the side. Grasping by means of the gripper of the loop holder from the side can thus be carried out transversely to the longitudinal axis of the machine, along or in relation to which the loop is aligned. The securing of the cable loop can advantageously be carried out at least during loop formation by means of the loop layer and preferably during placement on the cable tray. This arrangement also has the advantage that the space below the loop can be free, as a result of which an easy and unobstructed placement of the cable loop is ensured.

In a preferred embodiment, the installation has a loop layer that can be rotated about an axis in an arc-shaped movement. In a preferred embodiment, the axis of rotation for the described movement for loop laying can be such that a cable loop lying on a substantially vertical plane can be formed by means of the loop layer. The axis of rotation mentioned can be a horizontal axis. However, it can also be advantageous if the axis is inclined in space. The installation can be built compactly, in particular in the preferred embodiment. Placing the cable loop requires little space.

The loop stretcher can have a transfer element that can be shifted linearly by means of a drive. A linear axis with a belt drive, for example, can be used for linear shifting. It is particularly advantageous if the transfer element is a transfer element that can be shifted parallel to the longitudinal axis of the machine or parallel to the cable transport direction. The drive can also be another drive such as a linear drive instead of the belt drive.

The transfer element can have a horizontal engagement element that extends transversely, preferably at right angles, to the direction of shifting of the transfer element (which as a rule corresponds to the direction of the longitudinal axis of the machine or the direction of cable transport). The engagement element penetrates the cable loop and applies pressure to the loop from the inside. The transfer element is clearly a passive element that forms a stop about which the cable can be mounted through 180°, so that the cable loop has cable sections running parallel to one another. However, other wrap angles are also conceivable; in particular they can be smaller than 180°. This would result in a loop with cable sections running towards one another at an obtuse angle.

The installation can preferably have a loop stretcher with a shiftable transfer element and a loop holder formed by a gripper. If both machine components for securing the cable loop, i.e., both the loop stretcher and the loop holder, are provided in the installation, the installation can be operated particularly efficiently and safely without the risk of rolling over.

The linear drive of the loop stretcher can have a fixed bearing and a movable carriage guided on the bearing, on which carriage the transfer element is arranged, wherein the movement of the carriage is carried out by electromagnetic forces. Furthermore, a horizontal carrier structure can be provided, in which the specified fixed bearing of the linear drive or the linear axis of the loop stretcher is arranged. A carrier part for carrying the gripper for the loop holder can also be fastened to this carriage.

A further embodiment relates to an installation with which the loop holder is arranged in the region of a second pivot unit in the installation, so that a trailing cable end of the cable formed into a loop can be brought into a processing station by means of the second pivot unit, while the loop holder holds the cable, and that the cable loop thus retains its original shape at least in the region of the apex.

If the installation has a second pivot unit and at least one processing station assigned to it, it can be advantageous if the loop layer and the second pivot unit are designed in such a way that the fully assembled cable loop can be placed on the cable tray by means of the respective cable grippers of the loop layer, on the one hand, and the second pivot unit, on the other hand.

In each case, each pivot unit can have a base frame for the pivotable mounting of the pivot arm, to which the pivot arm is connected so that it can pivot about a vertical axis. A drive for pivoting the pivot arm can be arranged in the base frame. The pivot arm of the first pivot unit can be positioned on an upper side of a base frame for the pivotable mounting of the pivot arm. The pivot arm of the second pivot unit can be positioned on a lower side of a base frame for the pivotable mounting of the pivot arm.

For safe and reliable operation of the installation, it can be advantageous if the cable tray for a production batch comprises at least one holding element for holding a placed cable loop in the region of one cable end and preferably two holding elements for holding both cable ends of the cable loop. The holding of the cable ends can be carried out loosely for its arrangement. It is not absolutely necessary to actually hold or fix the cable in place. Of course, it is conceivable for certain applications if the holding element fixes the cable, e.g., by means of clamping force, so that it is held captively.

In particular, the holding element has the function of separating the cable ends of one batch from the cable ends of the next batch, but they can optionally also be designed to additionally fix the cable ends.

The at least one holding element can advantageously be designed in such a way that a plurality of cable loops of a production batch can be held. Thus, the holding element can hold a plurality of cable ends.

The at least one holding element can be detachably connected to the cable tray, so that it can be separated from the cable tray where required and transported together with the cable loop(s) for further processing. Other processing stations could be, for example, laying boards for cable harnesses. Mechanical connecting means, such as plug-in connections or latching connections, can be used for the detachable connection. As mechanical connecting means, actively operated locking mechanisms are particularly conceivable. However, it can also be advantageous if the at least one holding element is magnetically mounted to the cable tray. A permanent magnet can be integrated into the holding element for the magnetic connection, and the cable holder can consist of or comprise ferromagnetic materials.

The cable tray can be designed as a conveying device for transporting at least one production batch and preferably a plurality of production batches with fully assembled cable loops, wherein holding elements are arranged one behind the other on the cable tray in the case of a plurality of production batches. These holding elements can be advantageously arranged on the cable tray, preferably at regular intervals in relation to the conveying direction. The arrangement of the holding elements can be a fixed or only temporary (e.g., magnetic) arrangement.

In a preferred embodiment, the cable tray for forming a tray belt is designed as a conveyor, wherein the cable loops are placed on the upper section of the conveyor that moves or can be moved in the cable conveying direction. For example, the installation can be operated in such a way that the conveyor is stationary during the placement of the cable loops and that the conveyor is moved after the last cable loop of a batch has been placed. The conveying distance by which the conveyor is moved can correspond to the distance to the next holding element. This preferred embodiment with the cable tray designed as a conveyor could also be used with installations for assembling cables other than the pivot machine described above. The cable tray designed as a conveyor could, for example, also be advantageous for generically comparable installations that do not have loop stretchers and loop holders.

Preferably, the cable tray designed as a conveyor can have a conveyor belt running endlessly about end rollers, on which conveyor belt bases are arranged for specifying docking points, from which bases holding elements can be separated and to which bases holding elements can be attached.

Two holding elements can be provided for each production batch for the secure placement of the cable loops, wherein the respective holding elements are advantageously positioned on the edge of the conveyor belt of the conveyor.

The holding elements can be positioned on the conveyor belt of the conveyor in such a way that the holding elements or the cable ends held by them form a V-shaped configuration in a top view. Thanks to such an arrangement, the pivot unit of the installation can be used in an optimal manner.

As an alternative to the variant with the conveyor, the cable tray can be designed in such a way that it can be decoupled from the installation. In particular, the cable tray can be designed as a mobile cable tray unit or can be a component of a mobile cable tray unit, as a result of which the mobile cable tray unit can be uncoupled from the installation and transported separately from the installation by means of a transporting apparatus. This alternative embodiment with the mobile cable tray unit could also be used in other installations for assembling cables. The mobile cable tray unit could, for example, also be advantageous for generically comparable installations that do not have loop stretchers and loop holders.

The mobile cable tray unit can be configured for receiving a plurality of cable trays. The cable trays can be brought from a waiting position into a coupling position by means of a changing device, in which coupling position the respective cable tray can be coupled to the installation.

The mobile cable tray unit can, for example, have a flange for temporarily receiving a plurality of cable trays, which flange has a turret-like changing device with which cable trays can be rotated about a horizontal axis of rotation for changing, i.e., for transfer from the waiting position to the coupling position.

The mobile cable tray unit can also have a double-sided carrier unit, wherein the carrier unit is formed, for example, by the above-mentioned flange, on which carrier unit cable trays can be temporarily attached from two opposite sides. The advantage of this type of carrier unit, which is designed to have two sides for loading and unloading, is that the mobile cable tray unit only needs to be rotated by 180°.

The cable tray of a mobile cable tray unit can have a tray plate at least in a front region, in which cable ends of the cable loops can be placed, and preferably in a region in which the at least one holding element is provided. Thus, the cable tray is designed to be plate-shaped in the front region. In a rear region of the cable tray opposite the front, the cable tray can be designed in a trough shape.

The mobile cable tray unit for forming an autonomous conveyor trolley has a transporting apparatus that is able to move autonomously and thus largely independently of control signals that would otherwise have to be provided by an operator during the journey. The conveyor trolley can be moved relative to a floor by means of wheels. The conveyor trolley can comprise at least one electric motor, with which at least one of the wheels can be driven.

A further aspect of the invention can relate to a system with the installation described above and a transporting apparatus designed as an autonomous conveyor trolley for transporting the mobile cable tray unit. The system can comprise a plurality of autonomous conveyor trolleys.

### DESCRIPTION OF THE DRAWINGS

Additional advantages and individual features of the invention are derived from the following description of an exemplary embodiment and from the drawings. In the drawings:

FIG. 1 is a top view of an installation designed as a pivot machine for assembling cables according to the prior art,

FIG. 2 is a perspective view of the pivot machine according to FIG. 1,

FIG. 3 is a perspective view of an installation for assembling cables designed as a pivot machine according to the invention,

FIGS. 4 to 9 show the pivot machine from FIG. 3 in various positions when forming and assembling a cable loop,

FIG. 10 is a simplified representation of a cable loop after an undesired overlap,

FIG. 11 is a perspective view of an installation according to the invention with a pivot machine according to FIG. 3 and with a cable tray designed as a conveyor,

FIG. 12 is a simplified representation of a cable tray designed as a conveyor for the pivot machine in a side view,

FIG. 13 is a perspective view of an installation according to the invention with the pivot machine of the type shown in FIG. 3 and with an autonomous conveyor trolley for transporting cable trays for the pivot machine, and

FIG. 14 shows an alternative design of the arrangement in FIG. 13, wherein a conveyor trolley for transporting cable trays has been uncoupled from the pivot machine and removed from it.

### DETAILED DESCRIPTION

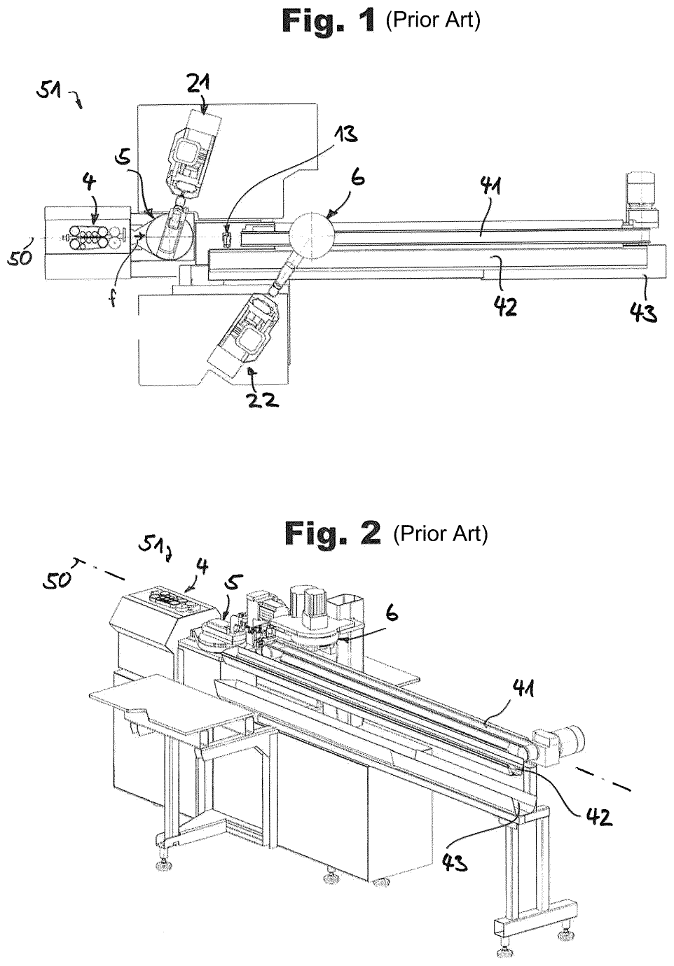

FIG. 1 shows a conventional installation of conventional design for assembling cables, designated in its entirety with 51. The installation 51 comprises a cable conveying device 4 designed as a belt conveyor, which moves the cable along a longitudinal axis 50 of the machine to pivot units 5 and 6. The cable conveying device 4 conveys the cable in the f-direction. A cutting and stripping station, with which the cable is cut to length and the two cable ends are stripped, is designated with 13. The cutting and stripping station 13 is clearly on the longitudinal axis 50 of the machine. The further processing stations 21 and 22 are located next to the longitudinal axis 50 of the machine in the top view. The pivot units 5, 6, which can be rotated about vertical axes, in each case have a cable gripper for holding the cable. The respective cable ends can be fed to the processing stations 21, 22 with the cable grippers of the pivot units 5, 6. The processing station 21 is used for processing the leading cable end of the cable and interacts with the first pivot unit 5. The processing station 22 is used for processing the trailing cable end of the cable and interacts with the second pivot unit 6. The installations 51 comprising such pivot units are also known to a person skilled in the art by the term “pivot machine.” Electrical cables, for example insulated stranded wires or solid conductors made of copper or steel, can be processed and assembled in the pivot machine 51. The cables to be processed are provided in drums, on rollers or as bundles (not shown).

In the design variant according to FIG. 1, the respective processing stations 21, 22 of the installation 51, which is designed as a pivot machine, in each case have a crimping module with a crimping press by way of example. During the assembly explained in the present case by way of example, the cable ends are initially cut to length and stripped, and then crimped. The cable ends can also be fitted with sleeves as required. In this case, the processing stations 21, 22 would also have sleeve modules. The respective processing station can thus comprise a plurality of processing modules, wherein the crimping module with a crimping press, a sleeve module and other modules such as a housing equipping module can be considered as processing modules. If applicable, a straightening unit (not shown), which is also located on the longitudinal axis 50 of the machine, can be arranged in front of the cable conveying device 4. FIG. 1 relates to an installation 51 for assembling cables (not shown), which remain straight. The installation 51 has a transport belt 41 for stretching the cable. The fully assembled cable piece then arrives in a cable trough 42, which is used for placement and temporary storage. The cable pieces can be brought from the cable trough 42 into a removal trough 43. Details on the design of such an assembly installation, in particular with regard to the troughs, can be found in EP 2 028 732 A2. The perspective representation in FIG. 2 shows the same installation 51 again.

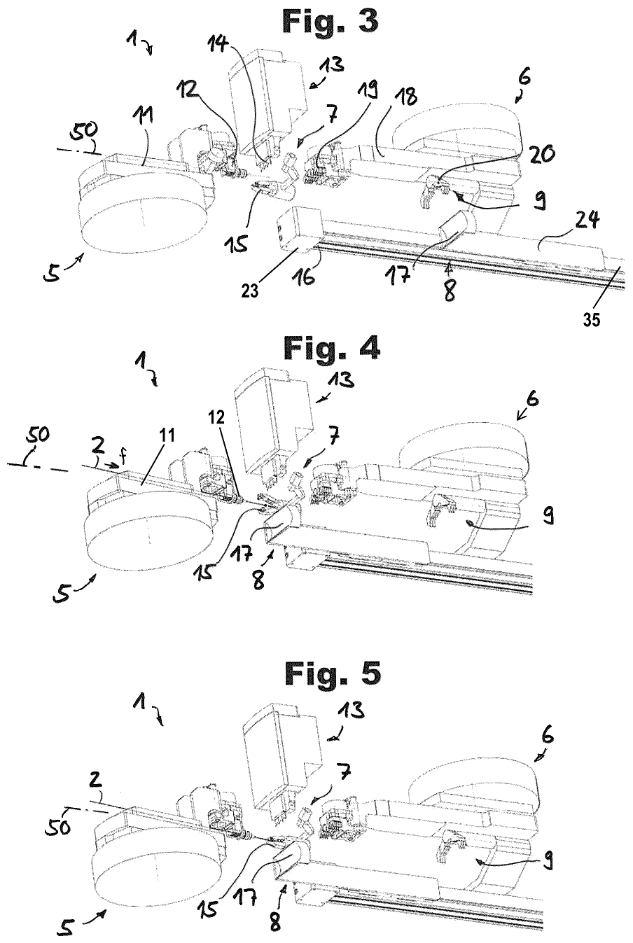

FIG. 3 shows a new type of installation 1 designed as a pivot machine for assembling cables according to the invention, with which no straight cable pieces are produced, but with which the cables are formed into cable loops. For the sake of simplicity, only the most important components of the pivot machine 1 in relation to the invention are shown in FIG. 3. In a manner known per se, the pivot machine 1 comprises a first pivot unit 5 with a pivot arm 11, which can be rotated about a vertical axis, with the cable gripper 12. The pivot machine 1 further comprises a second pivot unit 6 with a pivot arm 18, which can be rotated about a vertical axis, with the cable gripper 19. Although the processing stations assigned to pivot units 5 and 6 are also present, they are not shown here. The upper stripping blades 14 of the cutting and stripping station 13 can be seen in FIG. 3; the lower stripping blades opposite the upper stripping blades are not shown for a better understanding of the structure of the pivot machine 1. The basic structure of the pivot machine 1 with respect to the pivot units is the same or at least similar to that of the pivot machine 51 shown in FIG. 1. However, the arrangement shown in FIG. 3 differs in what is arranged in the region of and after the second pivot unit 6.

In each case, each pivot unit 5, 6 has a base frame for the pivotable mounting of the pivot arm 11, 18, to which base frame the pivot arm is connected so that it can pivot about a vertical axis. A drive for pivoting the respective pivot arm 11, 18 can be arranged in the base frame. The pivot arm 11 of the first pivot unit 5 can be positioned on an upper side of a base frame for the pivotable mounting of the pivot arm. The pivot arm 18 of the second pivot unit 6 can be positioned on a lower side of a base frame for the pivotable mounting of the pivot arm.

The pivot machine 1 is characterized by the fact that it has a loop layer 7 for forming cable loops from the cable, a loop stretcher 8, and a loop holder 9 formed by a gripper 20 for securing the cable loop. The pivot machine 1 can also have a cable tray (not shown here) for at least temporarily receiving a batch of fully assembled cable loops.

The loop layer 7 has a cable gripper 15 for gripping the leading cable end of the cable 2 (FIG. 4) and for laying the cable loop. The cable gripper 15 can be rotated about a horizontal axis and can form the loop from the cable by means of an arc-shaped rotary movement.

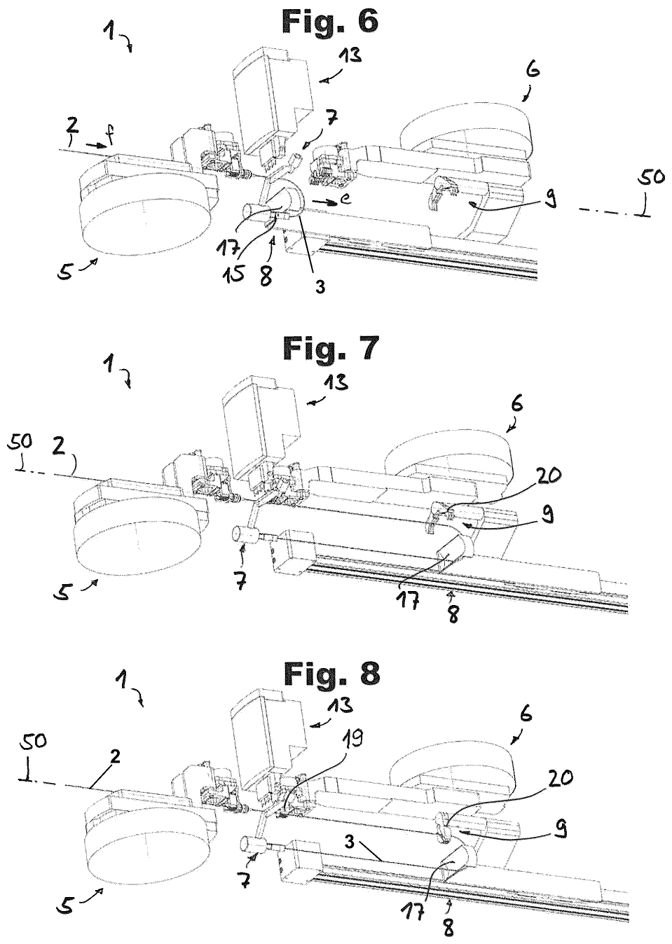

The loop stretcher 8 for stretching the cable loop comprises a transfer element 17 that acts on the loop in the region of the apex. The transfer element 17 can be shifted axially parallel to the longitudinal axis 50 of the machine by means of a drive 16. The transfer element 17 can grasp the cable and pull it in the e-direction (FIG. 6) axially parallel to the longitudinal axis 50 of the machine, as a result of which the loop is stretched and guided. The transfer element 17 subjects the loop to a tensile load at the apex. The loop holder 9 is substantially a gripper 20 that can grasp and hold the cable loosely from the side. Thus, the loop holder 9 acts on the cable loop in its lateral region, i.e., not on the apex, but in one of the regions of the cable loop that run parallel to one another. In other words, the loop stretcher 8 can be displaced along a linear axis parallel to the cable feed direction. This longitudinal movement depends on the desired cable length for the loop and should ideally be coordinated with the cable feed in order to stretch the loop in an optimal manner. The cable stretcher 8 is shaped in such a way that the cable is held passively while the loop is being stretched. Thanks to the loop stretcher 8, it can be ensured that undesired rolling over of the cable during or after loop formation can be prevented. The loop holder 9 also helps to prevent the cable from rolling over. The position of the loop holder 9 depends on the loop length. The linear movement of the loop stretcher 8 can be used for its positioning. FIG. 10 shows an undesired rolling over of a cable loop 3. Thanks to the loop holder 9, which uses its gripper 20 to take over the loop stretched by the loop stretcher 8, it is possible to ensure that the loop stretcher 8 can be moved back to its starting position prior to the formation of the next loop. Instead of the transfer element 17 shown here, other variants of loop stretchers would also be conceivable. Instead of the transfer element as a passive element, the loop stretcher could also comprise a pull-out gripper that embraces the cable and pulls it in the e-direction. It is also conceivable that the gripper 20 of the loop holder 9 takes over the stretching of the loop. In this case (not shown here), the gripper 20 would be a type of pull-out gripper that grasps the cable transversely to the longitudinal axis of the machine rather than from an axial side.

If the linear axis of the loop stretcher 8 is designed as a linear drive 16, it comprises a fixed bearing and a movable carriage 24 which is guided on the bearing and on which the transfer element 17 is arranged. In this case, the movement of the carriage 24 is carried out by electromagnetic forces. The bearing is integrated into a horizontal carrier structure 35. However, in the present exemplary embodiment, the linear axis drive 16 is a belt drive, preferably a toothed belt drive, which is installed in a housing 23. It can also be seen from FIG. 3 that a carrier part for carrying the gripper 20 for the loop holder 9 is fastened to the carriage 24. When the carriage 24 is moved for shifting the loop stretcher 8, the loop holder 9 is thus also moved.

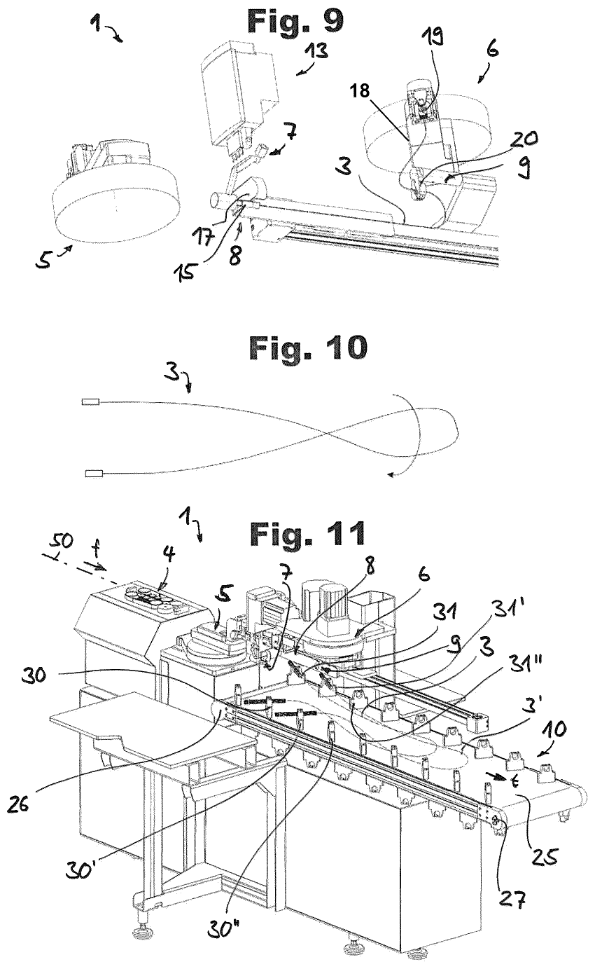

The mode of operation of the pivot machine 1 according to the invention is shown in the following figures. FIGS. 4 to 9 show how a cable loop 3 is formed from the cable 2 and how the assembled cable loop is created. FIG. 4 shows the pivot machine 1 prior to the start of loop formation. The cable designated with 2 is grasped by the cable gripper 12 of the first pivot unit 5. The leading cable end of cable 2 is already assembled. For this purpose, the cable 2 was stripped in the cutting and stripping station 13. As can be seen in FIG. 3, the cable gripper 15 of the loop layer 7 is located in an initial position next to the cutting and stripping station 13, so that the cable gripper 15 does not have to be shifted sideways out of the region of the blades during cutting and stripping. By pivoting the arm 11, the cable 2 was brought into the modules of the processing station (not shown here) and processed there, e.g., crimped, and then brought back into the slightly swung-out position shown in FIG. 3, in which it is aligned with respect to the cable gripper 15. The cable end already assembled in this way can now be taken over by the loop layer 7. As FIG. 4 shows, the cable end is brought into the open cable gripper 15 of the loop layer 7. The cable 2 can now be gripped by the cable gripper 15. The position with the cable gripper 15 closed is shown in FIG. 5. The cable gripper 15 now rotates about an axis and forms a loop by means of an arc-shaped rotary movement. The cable 2 is laid about the transfer element 17. As FIG. 6 shows, the cable gripper 15 of the loop layer 7 is rotated by 180° in this position. At the end of this rotary movement, the leading cable end is rotated by 180°. The aforementioned axis for the rotary movement for forming the axis is slightly inclined in space in the present exemplary embodiment, so that after the 180° rotation the cable gripper 15 is positioned in such a way that the cable loop 3 lies on a vertical plane. Thanks to the slightly inclined axis in relation to the horizontal, the cable gripper 15 does not have to be displaced sideways from the initial position shown in FIG. 3, in which it is positioned laterally next to the longitudinal axis 50 of the machine, in order to be able to grasp the cable 2 and then arrive at the position shown in FIG. 6. The cable gripper 15 of the loop layer 7 now remains in this position. The cable loop 3 can now be formed with the desired cable length. For this purpose, the cable is brought to the desired length by further feeding by means of the cable conveying device (not shown here) and the transfer element 17 of the loop stretcher 8 is shifted synchronously in the e-direction, which keeps the cable loop 3 stretched. This corresponding position is shown in FIG. 7. It can also be clearly seen here that the transfer element 17 has a horizontal engagement element extending at right angles to the direction of shifting of the transfer element. The engagement element penetrates the cable loop 3 and applies pressure to the loop from the inside. The transfer element 17 is a passive element that forms a stop about which the cable is mounted through 180°, so that the cable loop forms cable sections running parallel to one another. Once the transfer element 17 has been shifted completely and the cable loop 3 has reached the desired loop length, the second pivot unit 6 can now be activated. The cable gripper 19 of the second pivot unit 6 grasps the cable. At the same time or even before, the gripper 20 of the loop holder 9 encloses the cable in the upper section of the cable loop (FIG. 8). The cable 2 is cut to length in the cutting and stripping station 13 and the resulting cable end is stripped. The trailing cable end of the cable of the cable loop, which is grasped by the cable gripper 19 of the second pivot unit 6, is pivoted and brought into the modules of the processing station (not shown here) and processed there, e.g., crimped. FIG. 9 shows such a position in which the pivot arm 18 of the second pivot unit 6 is in a swung-out position. Once all the necessary processing has been carried out on the second cable end, the cable loop 3 is fully assembled and can be placed on a cable tray (not shown here). For this purpose, the loop layer 7 and the second pivot unit 6 can be designed in such a way that the fully assembled cable loop 3 can be placed on the cable tray by means of the respective cable grippers 15, 19 of the loop layer 7, on the one hand, and the second pivot unit 6, on the other hand. The cable loop 3 preferably remains under the influence of the loop holder 9 even when it is placed, so that holding the cable can prevent it from rolling over when it is placed. Accordingly, the loop holder 9 advantageously remains closed during placement; alternatively, it would also be conceivable for the loop stretcher 8 to remain in position in order to prevent the loop from rolling over.

Since the loop layer 7 is rotatable about an axis in an arc-shaped movement, a cable loop 3 is formed, which clearly lies on a substantially vertical plane. This arrangement has the advantage that the placement of the cable loop is easily possible, because there are no interfering parts or obstacles underneath the loop. The vertical alignment of the entire cable loop 3 during loop formation can clearly be seen, in particular in FIGS. 7 and 8. In the position shown in FIG. 9, the cable loop 3 is still in a vertical plane in some regions, i.e., from the front or leading cable end to the loop holder 9. One region of the cable loop 3 is no longer located in the specified vertical plane. The cable is swung out from the loop holder 9 up to the trailing cable end and is already aligned horizontally. Starting from such a swung-out position, at least the rear part of the cable loop could be placed, for example, by moving the cable gripper 19 downwards. The front part of the cable loop, as the part assigned to the leading cable end, can be placed by moving the cable gripper 15 downwards.

FIG. 11 shows a further installation 1 designed as a pivot machine for assembling cables, which is used to produce assembled cables in the form of cable loops. This pivot machine 1 comprises the cable conveying device 4 running along the longitudinal axis 50 of the machine for transporting the cable 2 (FIG. 8) in the cable transport direction f to processing stations, two pivot units 5, 6, the loop layer 7, the loop stretcher 8 and the loop holder 9 formed by the gripper 20 (FIG. 9). The pivot machine 1 also comprises a special cable tray 10, described in detail below, for receiving batches of fully assembled cable loops 3, 3′.

In the present case, the cable conveying device 4 of the pivot machine 1, designed as a cable feed, is designed as a belt conveyor. The cable 2 can be grasped in a clamping manner and transported between the two belts. The cable conveying device 4 could in principle also be designed as a roller drive. The cable conveying device can also have a length measuring device (not shown), which is arranged downstream of the belt drive and with which the length of the cable loop can be measured or checked.

In relation to the two pivot units 5, 6, the loop layer 7, the loop stretcher 8 and the loop holder 9, the pivot machine 1 is substantially designed in the same way as the pivot machine 1 shown in FIGS. 3 to 9. In this application, the cable tray 10 is understood to mean a tray for cables in the form of cable loops. In the exemplary embodiment according to FIG. 11, the cable tray 10 is designed as a conveyor for forming a tray belt, wherein the cable loops are placed on the upper section of the conveyor moving in the cable conveying direction. The transport direction of the conveyor is indicated by an arrow t, which clearly runs in the same direction as the previously mentioned cable conveying direction f. The conveyor comprises a conveyor belt 25 running endlessly about end rollers 26, 27.

Since, after being placed, the cables can still be displaced due to their elasticity and the movements of the pivot machine 1, it is advantageous to receive at least the front ends or the rear ends of a batch in holding elements. The holding elements prevent the cable ends of one batch from mixing with those of the next batch. According to the present exemplary embodiment for a production batch, the cable tray 10 comprises two holding elements 30, 31 for holding a placed cable loop 3, wherein, as can be seen from FIG. 11, each holding element 30, 31 holds one cable end of the cable loop.

Thus, two holding elements 30, 31 are provided for each production batch, wherein the respective holding elements 30, 31 are positioned on the edge of the conveyor belt 25 of the conveyor. The two holding elements 30, 31 for holding the placed cable loop designated with 3 are not in the same longitudinal position in relation to the longitudinal axis 50 of the machine or the cable conveying direction f or transport direction t, but are offset from one another by a distance.

The cable tray 10, designed as a conveying device for transporting a plurality of production batches with fully assembled cable loops, has a plurality of pairs of the holding elements 30, 31 (30′, 31′; 30″, 31″; etc.) arranged at regular intervals one behind the other in relation to the conveying direction, which are permanently or only temporarily connected to the conveyor or, more precisely, to the conveyor belt 25 of the conveyor.

In the exemplary embodiment shown here, exactly one cable loop 3 is held in the two holding elements 30, 31 and exactly one cable loop 3′ is held in the two holding elements 30′, 31′. Of course, it can also be advantageous if the holding elements 30, 31 hold a plurality of cable loops. Each holding element 30, 31 can thus be designed in such a way that a plurality of cable loops of a production batch can be held.

With this version of the cable tray 10, the batches are placed on the tray belt 25, which moves a certain distance along the longitudinal axis 50 of the machine or in the t direction after each placed batch. The holding elements on the tray belt are arranged at this distance accordingly.

In this embodiment of the cable tray 10, the holding elements 30, 31 are arranged one behind the other on the conveyor at a distance in the direction of the longitudinal axis 50 of the machine, which corresponds to the transport direction t; and the conveyor is moved by this distance after a batch has been placed. The holding elements 30, 31 can be firmly connected to the conveyor or can be detachably fastened, for example magnetically, in order to allow the batches to be removed together with the holding elements.

The batches are removed at the end of the tray belt 25 either by an operator by hand or by an automatic system such as a robot. The empty holding elements 30, 31 are moved back to the start of the tray belt on the lower side of the tray belt. A sensor (not shown), for example a light barrier, can be located at the end of the tray belt, and ensures that the pivot machine 1 only continues production if the batch has been removed at the last position.

The holding elements 30, 31 (30′, 31′; 30″, 31″; etc.) are positioned on the conveyor belt 25 of the conveyor in such a way that they or the cable ends held by them form a V-shaped configuration in a top view.

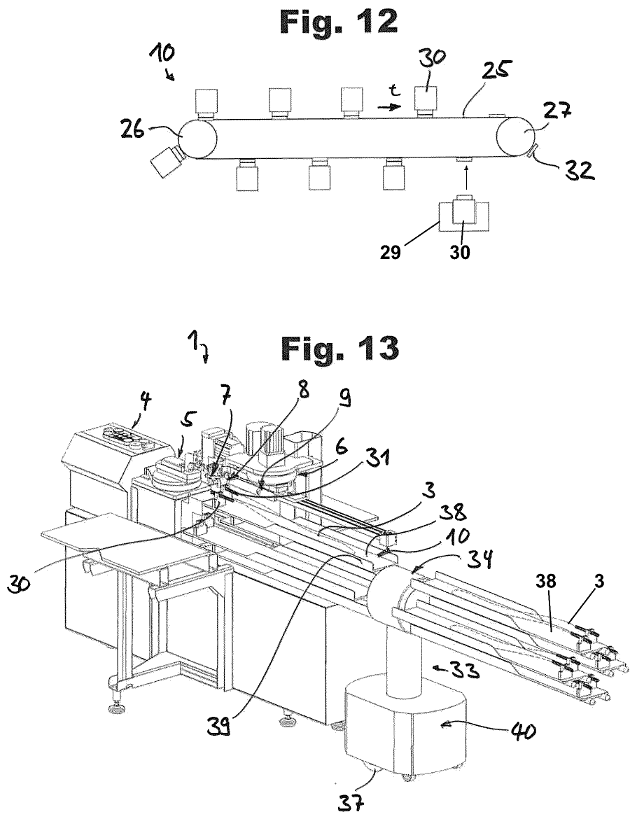

FIG. 12 relates to a variant with which the holding elements are detachably connected to the cable tray 10. Where required, a holding element 30 can be detached from the cable tray, which is also designed here as a conveyor, and transported together with the cable loop for further processing. Bases 32 are arranged on the conveyor belt 25 of the conveyor for specifying docking points, from which bases 32 holding elements 30 can be separated and to which bases holding elements 30 can be reattached. The separation of the holding elements advantageously takes place in the region of the rear end of the conveyor on the upper side with respect to the transport direction t. The empty holding element 30 can be docked back onto the respective base 32 on the lower side of the conveyor. Docking is indicated in FIG. 12 by an arrow pointing upwards. A docking device 29 for an automated process can be used for this purpose. Accordingly, the holding elements 30 can be fixed again to the conveyor after removal of the batches, which can be undertaken by an automatic return system in the returning part of the conveyor lying under the contact surface of the batches. However, docking could also be carried out manually.

Permanent magnets, for example, can be used for the detachable connection of the holding elements 30. The magnetic attachment or application of the holding elements 30 to the cable tray 10 would be easy to handle and particularly suitable for automated processes. Alternatively or additionally, mechanical connecting means for detachably connecting the holding elements 30 to the cable tray 10 would also be conceivable, wherein actively operated locking mechanisms would be particularly advantageous for automatic removal.

The cable tray 10 could also be formed by a tray plate, for example. Thus, the cable tray does not necessarily have to be designed as a conveying device for transporting at least one production batch and preferably a plurality of production batches with fully assembled cable loops. However, the cable tray could also be separated from the pivot machine as a whole. Thus, the installation 1 according to the invention can be designed in such a way that the cable tray can be decoupled from the installation. FIG. 13 shows a possible design of such a cable tray for the pivot machine. In the exemplary embodiment according to FIG. 13, the cable tray 10 is a component of a mobile cable tray unit designated with 33. The mobile cable tray unit 33 can be uncoupled from the pivot machine 1 and can be transported separately from it to any desired location.

In this version of the cable tray 10, in each case the placement of one or more batches is carried out on a tray plate, which is removed after placement by a transporting apparatus 40 described in detail below. The tray plates also have holding elements 30, 31, which fulfill the functions already mentioned above. In the event that only one batch is placed on the tray plate, it would also be conceivable to dispense with holding elements.

The mobile cable tray unit 33 has a transporting apparatus 40 that is capable of moving autonomously for forming an autonomous conveyor trolley. The conveyor trolley can be moved relative to the floor by means of wheels 37. The conveyor trolley can comprise at least one electric motor (not shown), with which at least one of the wheels 37 can be driven.

In the present exemplary embodiment, the transporting apparatus 40, consisting of autonomous conveyor trolleys, independently transports cable batches from the pivot machine 1 to further processing stations, such as laying boards for the cable harnesses. However, other transport systems such as overhead conveyors or horizontal conveyor systems with rails or conveyors are also conceivable as the transporting apparatus.

In the present case, by way of example, the mobile cable tray unit 33 is configured for receiving a plurality of cable trays 10. The cable trays 10 in the mobile cable tray unit 33 can be brought from a waiting position into a coupling position by means of a changing device, in which coupling position the respective cable tray 10 can be coupled to the pivot machine 1. For the aforementioned changing of the cable trays, the installation 1 designed as a pivot machine can have a mobile cable tray unit 33 with a flange 34 for temporarily receiving a plurality of cable trays 10, which flange has a turret-like changing device with which cable trays 10 can be rotated about a horizontal axis of rotation for changing.

The cable tray 10 of or for the mobile cable tray unit 33 has a tray plate 38 at least in a front region in which the cable ends of the cable loops can be placed. In the present case, the cable tray 10 is clearly designed to be plate-shaped in the front region. In a rear region of the cable tray 10 opposite the front, the cable tray is designed in a trough shape. Side wall sections for specifying the inner trough shape are designated with 39.

The conveyor trolley 33 receives a plurality of tray plates 38 on both sides, which are fastened to the rotatable flange 34. By rotating, an empty tray plate 38 can successively be brought into the top position, in order to allow a batch to be placed on it. Once one side of the conveyor trolley is full, it moves away from the pivot machine 1, rotates 180 degrees and places the empty tray plates on the other side into the pivot machine.

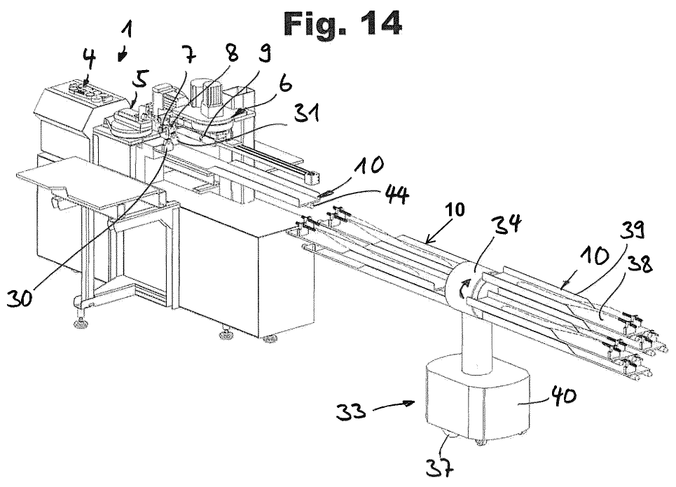

As can be seen from FIG. 14, the mobile cable tray unit 33 of the installation 1 can have a carrier unit designed to have two sides and formed in the present case by the flange 34, to which carrier unit cable trays 10 can be temporarily attached from two opposite sides.

In the variant according to FIG. 14, the tray plate 10 currently being loaded can remain on the pivot machine 1, while the transporting apparatus conveyor trolley 40 is already on its way to remove the full tray plates 10. It would also be conceivable that the pivot machine 1 itself has a changer (not shown here) for a plurality of tray plates in order to increase the autonomy of the pivot machine.

The respective cable tray 10 can be received by the mobile cable tray unit 33 as follows. A bolt-like connecting part 44 of the cable tray 10, which can be inserted into a complementary receptacle in the flange 34, can also be seen from FIG. 14. Where required, the flange 34 is rotated in the direction of the arrow until an empty receiving position is reached and the mobile cable tray unit 33, which is designed as an autonomous conveyor trolley, then moves to the pivot machine 1 and the plug connection is created between the cable tray 10 and the carrier unit of the mobile cable tray unit 33. A plurality of such mobile cable tray units 33 designed as autonomous conveyor trolleys can be provided, which together with the at least one pivot machine 1 form a system.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An installation for assembling cables, the installation having a first pivot unit and a processing station processing cable ends of the cable, the installation comprising:
a loop layer forming cable loops from the cable; and
a loop stretcher and/or a loop holder, the loop holder formed by a gripper, individually securing each of the cable loops.

2. The installation according to claim 1 wherein the loop stretcher includes a transfer element that is shifted linearly by a drive.

3. The installation according to claim 2 including the loop stretcher with the shiftable transfer element and the loop holder formed by the gripper.

4. The installation according to claim 1 including a second pivot unit and a cable tray, the cable tray adapted to at least temporarily receive a batch of fully assembled cable loops, wherein the loop layer and the second pivot unit place each of the fully assembled cable loops on the cable tray by a cable gripper of the loop layer and another cable gripper of the second pivot unit.

5. The installation according to claim 1 including a cable tray adapted to at least temporarily receive a batch of fully assembled cable loops, wherein the cable tray has a holding element adapted to hold one of the fully assembled cable loops in a region of one cable end of the one fully assembled cable loop.

6. The installation according to claim 5 wherein the holding element is adapted to hold at least two of the fully assembled cable loops in the region of the one cable end of each of the fully assembled cable loops.

7. The installation according to claim 5 wherein the holding element is detachably connected to the cable tray.

8. The installation according to claim 1 including a cable tray adapted to at least temporarily receive a batch of fully assembled cable loops, wherein the cable tray has two holding elements each adapted to hold at least two of the fully assembled cable loops, the holding elements holding each of the fully assembled cable loops in regions of opposite cable ends of the fully assembled cable loop.

9. The installation according to claim 1 including a cable tray adapted to at least temporarily receive a batch of fully assembled cable loops, wherein the cable tray has a plurality of holding elements each adapted to hold at least two of the fully assembled cable loops, the holding elements holding each of the fully assembled cable loops in regions of opposite cable ends of the fully assembled cable loop, wherein the cable tray is adapted to transport the batch as a production batch.

10. The installation according to claim 9 wherein the cable tray is adapted to receive a plurality of batches of the fully assembled cable loops and to transport the plurality of batches as a plurality of production batches of the fully assembled cable loops.

11. The installation according to claim 9 wherein the cable tray is a conveyor.

12. The installation according to claim 11 including a plurality of bases arranged on a conveyor belt of the conveyor, each of the bases specifying a docking point to which one of holding elements is attachable and from which an attached one of the holding elements is separable.

13. The installation according to claim 9 wherein different pairs of the holding elements hold each of the production batches, wherein the cable tray is a conveyor having a conveyor belt, and the holding elements of each of the pairs of the holding elements are positioned on opposite edges of the conveyor belt.

14. The installation according to claim 9 wherein different pairs of the holding elements hold each of the production batches, wherein the cable tray is a conveyor having a conveyor belt, and the holding elements of each of the pairs of the holding elements are positioned on the conveyor belt such that the fully assembled cable loops are held in a V-shaped configuration in a top view.

15. The installation according to claim 1 including a second pivot unit and a cable tray, the cable tray adapted to at least temporarily receive a batch of fully assembled cable loops, wherein the loop layer and the second pivot unit place each of the fully assembled cable loops on the cable tray by a cable gripper of the loop layer and another cable gripper of the second pivot unit, wherein that the cable tray is a component of a mobile cable tray unit adapted to be uncoupled from the installation and transported by a transporting apparatus.

16. The installation according to claim 15 wherein the mobile cable tray unit receives a plurality of the cable tray, and wherein the mobile cable tray unit includes a changing device that selectively bring each of the cable trays from a waiting position into a coupling position, in which coupling position the cable tray can be coupled to the installation.

17. The installation according to claim 16 wherein the mobile cable tray unit has a flange that temporarily receives a plurality of the cable tray, the flange having the changing device that rotates the cable trays about a horizontal axis of rotation to move the cable trays between the waiting position and the coupling position.

18. The installation according to claim 15 wherein the cable tray has a tray plate in a front region and at least one holding element on the tray plate, the at least one holding element adapted to hold a cable end of at least one of the fully assembled cable loops.
